(19) United States
(12) Patent Application Publication
(10) Pub. No.: US 2015/0314538 A1
(43) Pub. Date: Nov. 5, 2015

(54) METHOD AND DEVICE FOR MANUFACTURING A COMPOSITE PART BY DRAPE FORMING

(71) Applicant: AIRCELLE, GONFREVILLE L'ORCHER (FR)

(72) Inventors: Guy Bernard VAUCHEL, HARFLEUR (FR); Eric PILLON, BENARVILLE (FR); Jean-Luc MAZZONI, BENARVILLE (FR)

(21) Appl. No.: 14/333,785

(22) Filed: Jul. 17, 2014

Related U.S. Application Data
(63) Continuation of application No. PCT/FR2013/050037, filed on Jan. 8, 2013.

(30) Foreign Application Priority Data
Jan. 17, 2012 (FR) 12/50430

(51) Int. Cl. B29C 70/46; B29C 70/34

(52) U.S. Cl. CPC B29C 70/462; B29C 70/34; B29C 70/342; B29L 2031/3076

(57) ABSTRACT

The present disclosure relates to methods for manufacturing a part made from a composite material by means of a drape forming operation as well as to a tool for implementing the methods. In particular, the part has at least one inner convex surface. The methods use at least one outer manufacturing mold and at least one intermediate mold. The inner surface of the outer manufacturing mold substantially defines outer lines of the part to be manufactured, and the intermediate mold is arranged opposite the inner surface of the outer manufacturing mold such that an inner surface of the intermediate mold at least partially defines the molding lines of an intermediate portion of the part to be produced.

### CROSS-REFERENCE TO RELATED APPLICATIONS

This application is a continuation of International Application No. PCT/FR2013/050037, filed on Jan. 8, 2013, which claims the benefit of FR 12/50430, filed on Jan. 17, 2012. The disclosures of the above applications are incorporated herein by reference.

### FIELD

The present disclosure relates to a method for manufacturing a part made of composite material as well as a device for implementing the method.

### BACKGROUND

The statements in this section merely provide background information related to the present disclosure and may not constitute prior art.

The manufacturing of a part made of composite material is usually made by a molding method and impregnation of fibers with resin which is subsequently polymerized.

Generally, such a manufacturing method comprises a step of placing fiber plies onto the surface of a mold, step called draping operation, followed by a step of polymerizing a resin surrounding the fibers.

Many implementation alternatives may be cited. First, the resin may already be present during placing the plies, what is referred to as pre-impregnated plies. After draping the pre-impregnated plies, the polymerization of the whole is performed in an autoclave. This type of method is commonly called manual draping.

Other alternatives use dry plies and comprise a step of adding resin.

In the resin transfer molding method, or RTM, the adding of resin is performed by injection under pressure inside a mold/counter mold set containing the plies.

The mold is generally called female mold or matrix, and the counter mold constitutes a male portion, also called punch.

The resin infusion molding method may also be cited, wherein the mold is closed by means of a flexible cover allowing the controlled passage of a resin which will infuse inside fibrous reinforcing elements and will subsequently polymerize, in order to give a rigid part.

The propagating of resin is made by a driving force created by a depression at certain points of the cover, towards which the resin introduced into the mold moves.

In the conventional infusion method, the molding tooling is thus formed of a matrix mold and a sealed cover such as a canvas sheet as a counter mold portion.

These methods for manufacturing composite parts, whether they are manual draping, RTM or resin infusion, are technologies in which the molding tooling is heavy and designed for a shape of a specific part intended to be made. This results in high tooling costs to be able to make very varied parts.

For both technical reasons related to the integrity and mechanical properties of the composite material part and economic reasons aiming to limit the molding and demolding operations, it is desirable to be able to make whole parts in a single molding/demolding operation.

Making parts less than 180° in circumference is relatively easy. However, this is not the case for parts with geometries extending over a large angular area exceeding 180° and having non-demoldable lines, that is to say, not allowing extraction of the mold after the part has been made.

In such a case it is then necessary to make a mold in several demountable portions allowing extraction of each portion after molding.

This makes the manufacturing operation more complex, requires additional time of assembly and disassembly of the mold and results in significant additional manufacturing costs of the mold.

An example of a part particularly difficult to make with composite material by this type of method is an outer structure of a turbojet engine nacelle such as a thrust reverser movable cowl for a called O-duct-type nacelle structure.

Specifically, an aircraft is moved by a number of turbojet engines each accommodated in a nacelle used to channel the air flow generated by the turbojet engine, which may also house a set of devices providing various functions such as a thrust reversal device the role of which is to improve the braking ability of the aircraft by redirecting forward at least a portion of the secondary air flow.

A nacelle generally has a tubular structure comprising an air inlet upstream of the turbojet engine, a middle section intended to surround a fan of the turbojet engine, and a downstream section housing the thrust reversal means and intended to surround the combustion chamber of the turbojet engine, and is generally terminated by an ejection nozzle the outlet of which is situated downstream of the turbojet engine.

The thrust reversal device comprises reversal means which, in a reversal phase, allow obstructing at least partially the cold flow path and redirecting at least a portion of the latter forward of the nacelle, thereby generating a counter-thrust which is added to the braking of the aircraft wheels.

The means implemented to achieve this cold flow reorientation vary depending on the type of the thrust reverser. However, in all cases, the structure of a thrust reverser comprises one or more movable cowl(s) displaceable between an open or “reverse jet”, position in which they open a passage in the nacelle intended for the diverted flow and a closed, or “direct jet”, position in which they close this passage.

In the case of a cascade-type thrust reverser, the reorientation of the airflow is performed by cascade vanes and the movable cowl have only a simple sliding function with the aim to uncover or re-cover these cascades.

According to one form, it is known a nacelle intended to be supported by a pylon of the turbojet engine comprising a thrust reversal device having a substantially peripheral and almost annular single one-piece movable cowl, slidably mounted on rails disposed on either side of said pylon.

Such a cowl is often referred to as “0-duct”, with reference to the ferrule-shape of such a cowl, as opposed to the “D-duct”, which actually comprises two half-cowls each extending over half the circumference of the nacelle.

It is, therefore, understood that making such an O-duct type cowl from composite material by a single molding is a delicate and difficult operation.

A solution currently used consists in making the ferrule constituting the panel from the inner aerodynamic surface (outer flow path) up to the outside of the nacelle before attaching mechanically all or part of the outer aerodynamic structure of the component of the nacelle.

Generally, the inner aerodynamic line of the thrust reverser structure is not demoldable, that is to say, it has a convex shape which prevents demolding the part made by simple extraction in one direction or the other of the molding tooling. The solution for making such a structure from composite material consists in adopting male tooling in several heavy, complex and unreliable portions.

Specifically, a tooling called key tooling is generally used.

Such a tooling usually consists of three, four or five portions, of which fixation between the elements is made internally to the structure either mechanically by bolting or by a complex system of automatic binding and handling of keys.

To manufacture the ferrule of the 0-duct type movable thrust reverser, one may proceed as follows.

First, the keys are assembled and sealed together. An inner skin is then draped, polymerized, disassembled and perforated if necessary in case of acoustic application on the ferrule underway.

Cores forming the inner structure to impart inertia to the ferrule may for example consist of honeycomb or foam structures. These core elements are positioned and anchored on the first skin (inner skin).

A skin intended to form the outer skin is over-draped on the core elements and the whole is polymerized to form the first element of the movable cowl.

Independently, an outer ferrule resting on the aerodynamic outer lines is made and assembled mechanically on the inner element of the movable ferrule.

The disadvantages of a key tooling structure are in particular:
the difficulty and even the impossibility of obtaining a proper sealing between the keys leading to an increase in the making cycle time of the part or a part to be discarded or machined,
the risks of degradation of the aerodynamic surface linked to the junctions of the keys,
the presence of bulky, costly and heavy-to-handle element resulting in a potential damage to the mold elements during handlings, a significant time to be devoted to the handling of the keys, as well as the need for a suitable workstation allowing operators to access to the keys,
the need to recondition the keys after each polymerization with the risk of damage of the latter at each isolated handling.

Moreover, this results in several disadvantages on the assembled part due to the key tooling. This includes the need of having an attached outer panel, but also the difficulty of subsequently installing an intermediate reinforcement frame of said outer panel, due to increasingly tightened aerodynamic lines which reduce access and make the adjustment of fasteners difficult.

One may also mention the presence of fasteners on the outer portion and even the inner portion due to the mechanical input of the outer structure, as well as the possible presence of an aerodynamic degradation on the quality of the outer line due to possible improper positioning of the outer panel on the inner ferrule at the junction interface.

Thus, there is a great need for a tooling and implementation solution allowing the making of such an O-duct type structure, and more generally of any composite part extending over more than 180 degrees and/or having a convex inner structure making its demolding impossible.

### SUMMARY

The present disclosure relates to methods for manufacturing a composite material part by at least one polymerizing and draping operation, said part having at least one convex inner surface, comprising the following steps aiming at:
disposing on an inner surface an outer manufacturing mold defining at least in part the lines of an outer surface of the part to be made, elements necessary to the making of an outer portion of the part to be made,
proceeding to the making of said outer portion of the part to be made by resin injecting method and at least partial polymerization of this resin,
installing at least at a portion of an inner surface of the previously made outer portion, an intermediate mold an inner surface of which aims, firstly, to provide an interface with a remaining portion of the inner surface of the previously made outer portion, and secondly, to define at least in part, the molding lines of an intermediate portion of the part to be made,
disposing the elements of the intermediate portion and proceeding to its making by draping operation and at least partial polymerization of this resin,
disposing on the made intermediate portion, the elements of a remaining inner portion to be made and proceeding to its making by draping operation and at least partial polymerization of this resin.

Thus, by providing for an outer main mold and starting the making of the part from an outer portion to an inner portion, that is, contrary to prior technique, it is possible to avoid using molds in inner areas with non-demoldable geometry.

The outer mold may thus be formed in one-piece and without a mechanical part nor keys. Placing the tooling is also more rapid.

Complementarily, the example method comprises an additional intermediate step of re-machining the made outer portion. This re-machining aims to provide a proper interface with the portions to come.

Advantageously, the step of making the outer portion and the step of making the intermediate portion are made in one common step.

In one form, at least some of the elements of the inner portion are pre-polymerized before installation of the remaining elements and final polymerization.

The present disclosure also relates to toolings for implementing methods for manufacturing a composite material part having at least one convex inner surface comprising:
at least one outer manufacturing mold, an inner surface of which substantially defines the outer lines of the part to be made, and
at least one intermediate mold able to be disposed opposite the inner surface of the outer mold and designed such that an inner surface of said intermediate mold defines at least a portion of the molding lines of an intermediate portion of the part to be made.

Advantageously, the intermediate mold is equipped with means for positioning relative to the outer mold.

Advantageously, the outer mold comprises corresponding means for complementary positioning.

In another form, the intermediate mold is equipped with a counter-shape bladder intended to be oriented toward the inner surface of the outer mold and complementary to at least a portion of the molding surface of the outer mold.

Advantageously, the intermediate mold is equipped with at least one portion made from flexible material of elastomer material type, particularly at connecting angle irons.

Advantageously, the tooling comprises means for sealing between the outer mold and the intermediate mold.

In still another form, the outer mold extends over at least 180° in circumference.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a longitudinal sectional schematic representation of an outer cowl of a thrust reverser for a turbojet engine nacelle made of composite material according to prior art;

FIG. 2 is a representation of the elements constituting a movable cowl similar to the cowl of FIG. 1 that may be manufactured according to the methods described in the present disclosure;

FIGS. 3 and 4 are perspective views of an example tooling for implementing the described methods for manufacturing the cowl of FIGS. 1 and 2; and

FIGS. 5 to 13 are longitudinal sectional schematic views of the different steps in example methods for making the cowl of FIG. 1 described in the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

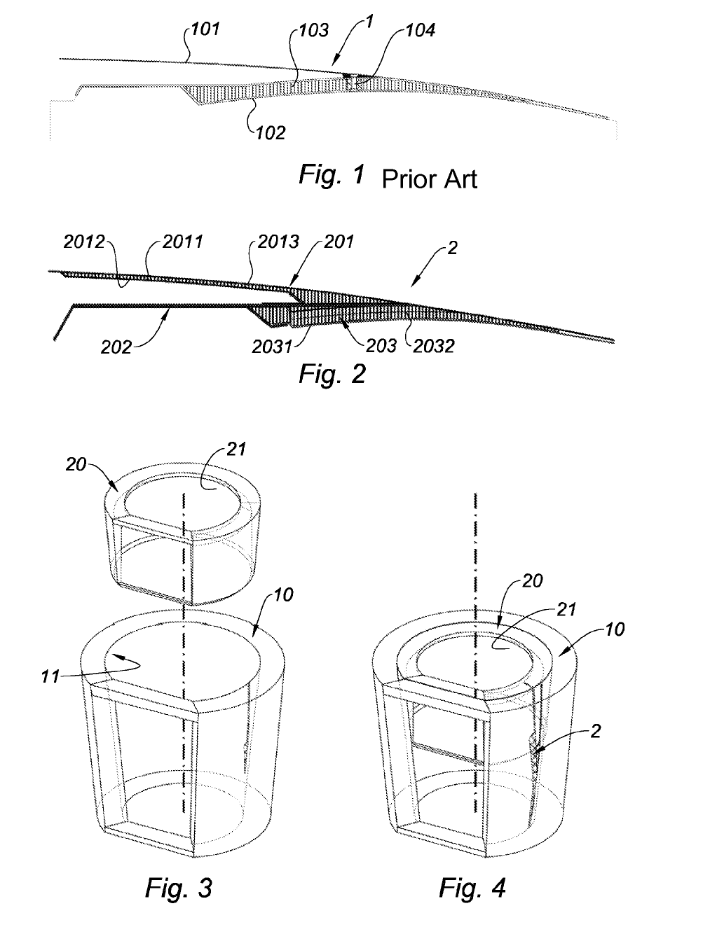

FIGS. 1 and 2 show a longitudinal sectional view of an O-Duct type thrust reversal movable cowl 1 to be made from composite material using the methods according to the present disclosure. As mentioned above, this type of movable cowl extends over almost the entire periphery of the nacelle with the exception of an upper area intended to the passage of a pylon for fastening the turbojet engine. More generally, this movable cowl extends over more than 180° of angular section, which makes the manufacturing in one-piece and the demolding thereof particularly complex as explained in the introduction to this application.

More specifically, the movable cowl 1 has an inner aerodynamic surface intended to define an outer surface of an air flow path. This inner surface is a non-demoldable convex surface, that is to say, which prevents demolding the part thus made by simple extraction of the tooling in one direction or in the other.

It should of course be noted that the methods and the tooling object of the present disclosure are not limited to implementing such a movable cowl and relate more generally to any composite material structure having a non-demoldable convex surface.

Generally, as shown in FIG. 1, a cowl 1 made of composite material comprises:
an outer ferrule 101 defining outer aerodynamic lines of the nacelle,
an inner ferrule 102 defining inner aerodynamic lines of the cold airflow path, and optionally equipped with an acoustic attenuation structure with a perforated acoustic skin, and
the cores 103 forming the inner structure of the cowl 1. These cores may conventionally be honeycomb panels or foam panels.

As mentioned above, the making method according to prior art is based on the initial manufacture of the inner ferrule 102 and installation of the cores. The outer ferrule 101 is manufactured independently then attached and fixed mechanically (fastener 104) on the initially manufactured inner ferrule 102. The manufacture of the movable cowl 1 is then performed substantially from the inside to the outside using an inner male mold. The disadvantages of such a form were mentioned above.

Example methods according to the present disclosure propose to make a movable cowl 2 from the outer ferrule to the inside of said cowl 2 using a main outer female mold and able to be made in one-piece.

The outer aerodynamic lines of the nacelle are defined at this level by said main outer mold downstream of the mid-ship section of the nacelle and therefore in a demoldable geometry upstream of the made structure.

To do so, the cowl 2 is subdivided into several portions shown in FIG. 2.

Firstly, the cowl 2 has an outer portion 201 substantially corresponding to the outer ferrule 101, and comprising an outer skin 2011, an inner skin 2012, and a core structure 2013 located between the outer skin 2011 and the inner skin 2012.

The cowl 2 then has an intermediate portion 202 substantially corresponding to an outer wall of the inner ferrule 102 and intended to provide the interface between an inner portion of the cowl 2 and the preceding outer portion 3.

The cowl 2 finally has an inner portion 203 comprising an inner skin 2031 and a core structure 2032.

The cowl 2 thus has a core panel at the junction of the outer ferrule and the inner ferrule.

This cowl 2 is made according to the method of the present disclosure.

To do this, the method uses a tooling shown in FIGS. 3 and 4 and comprising:
at least one outer manufacturing mold 10 an inner surface 11 of which substantially defines the outer lines of the cowl 2 (outer portion 201), and
at least one intermediate mold 20 able to be disposed inside the outer mold 10 opposite the inner surface 11 of the outer mold and designed such that an inner surface 21 of said intermediate mold 20 defines at least in part the molding lines of the intermediate portion 202 of the cowl 2.

The outer mold 10 will be advantageously made in one-piece (monoblock), over an angular sector corresponding to the one of the part to be made. Of course, if the tooling does not need to cover a part on a sector greater than approximately 330° in circumference, it may include an access opening or a visual opening of the inside of the tooling.

In this particular case, it will be noted that the cowl 2 has an open structure for the passage of a fastening mast, this opening may be added at the outer mold 10 and the inner mold 20, and act as an access opening and/or a visual control opening.

Advantageously, for handling and arrangement reasons of item, the tooling set is defined vertical and the most flared portion could be positioned upwardly.

According to advantageous complementary characteristics, the intermediate tooling is sealed on the outer tooling:
the intermediate tooling is centered relative to the outer tooling,
the intermediate tooling is subject to the outer tooling,
the intermediate tooling is self-centered over at least a portion of the inside of the outer ferrule.

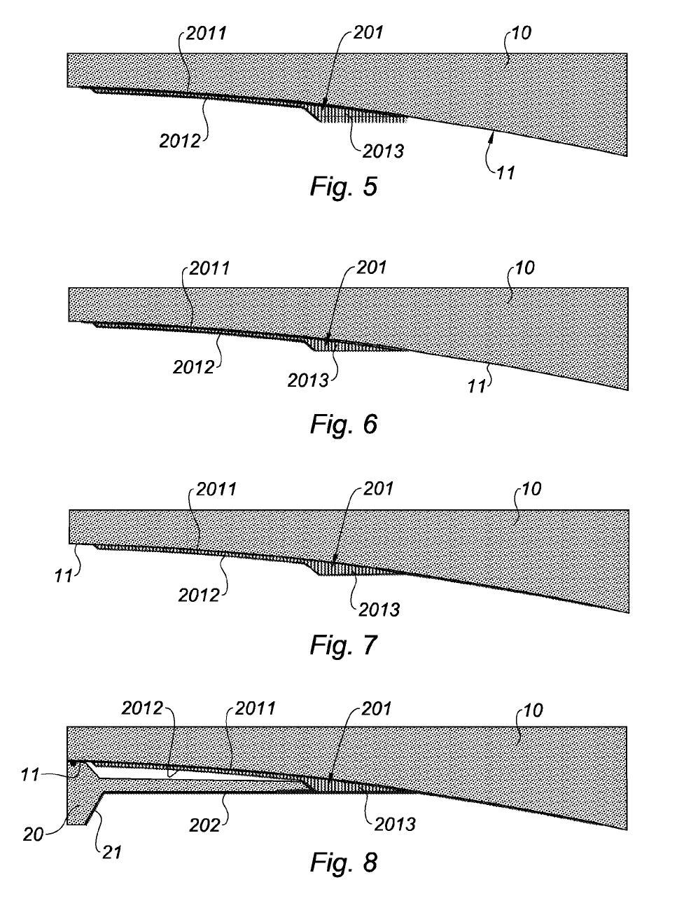

Example manufacturing methods according to the present disclosure will now be described in detail with reference to FIGS. 5 to 13.

A first step consists in making the outer ferrule, and more precisely the outer portion 201 (FIGS. 5 to 7).

The outer portion 201, representing all or part of the outer surface of the cowl 2, is made in one operation.

To do this, the elements for making said outer portion 201 are disposed on the inner surface 11 of the outer mold 10, and comprising:
an outer skin 2011,
a core structure 2013 and/or inner reinforcements, and
an inner skin 2012.

According to a first form shown in FIG. 5, the outer skin 2011 is interrupted at the downstream portion at a level corresponding to a horizontal interface with a diaphragm face corresponding to the intermediate portion which will be made subsequently (step3).

The core structure 2013 is installed with an over-thickness toward the inside of the structure, the draping of the inner plies of the inner skin 2012 being equally made in a spillover state.

The whole is at least partially polymerized, and the inner face of the core 2013 and the inner skin 2012 are retouched by machining (FIG. 6 after machining) to provide a proper interface with the portions to come.

According to another form (not shown), it is possible to place cores with finished ribs and compensate potential gaps in the next step.

In yet another form (FIG. 7), it is possible to extend the draping of the outer skin 2012, in final thickness or in intermediate thickness up to the downstream end of the structure of the outer portion, and therefore almost over the entire inner surface 11 of the outer mold 10. The implementation of the rest of the structure is identical to the procedure of the first alternative of the partial outer skin.

A second step of the method is to make the Intermediate portion 202 (FIGS. 8 to 10).

To do this, an intermediate mold the inner surface 21 of which provides the interface with a portion of the inner surface of the outer portion 201 previously made and defines in part the molding lines of the intermediate portion 202 to be made is installed at a portion of the inner ferrule 2012 of the outer portion 201 previously made.

More precisely, the intermediate tooling 20 is configured to provide the downstream interface with the shape of the core 2013 downstream of the outer portion 201 and the inner skin 2012.

In one form, the intermediate tooling 20 is centered on the outer tooling 10. The upstream portion of the intermediate tooling 20 may in particular be centered on the outer tooling 10 either from the inside or by overlaying the intermediate tooling onto the outer tooling and an indexing, locating, centering and holding system, co-operating in particular with complementary indexing means of the outer mold 10.

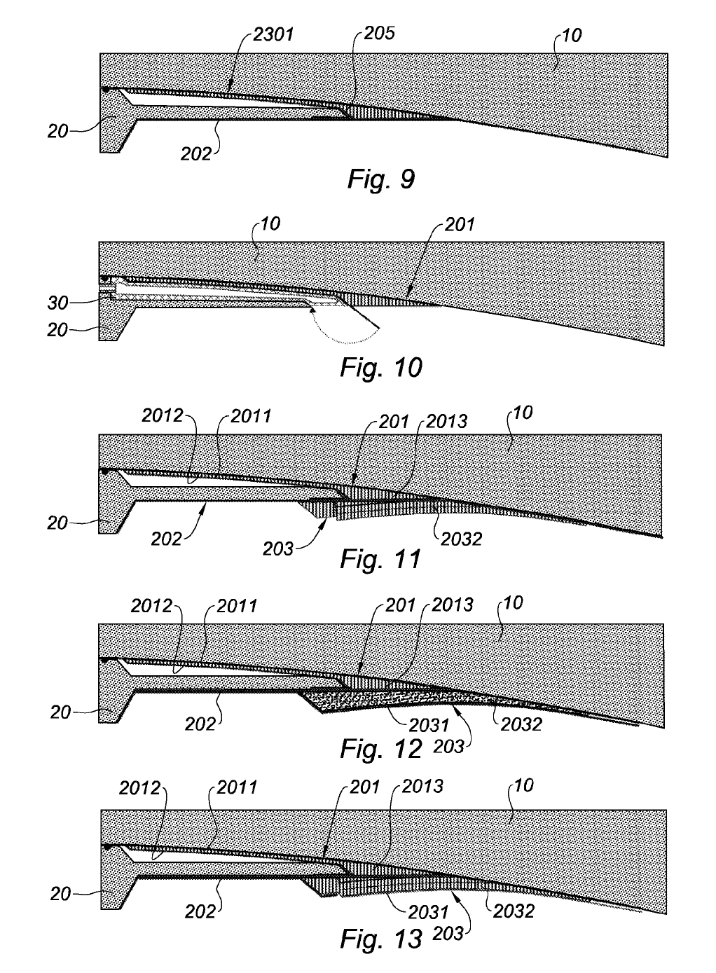

According to another form (FIG. 9), the downstream end of the intermediate tooling 20 may be made wholly or partly from an elastomer compound which allows integrating the shape gaps by providing contact pressure for a reinforcement alternative of the outer portion 201 with the inner portion 203 to come via composite plies acting as a connecting angle iron 205. This angle iron 205 may even be attached in finished configuration.

This reinforcing angle iron 205 links at least the inner return of the inner skin 2012 of the outer portion 201 with the outer surface of the plies of the intermediate portion 202.

The intermediate portion 202 to be made is in this particular case a separating diaphragm between the outer portion 201 comprising a set of plies forming a wall.

Once the plies constituting this intermediate portion 202 are installed, we proceed to its making by draping operation and at least partial polymerization of the resin.

A sealing may be associated between the two toolings 10, 20 to isolate the portion already polymerized (outer portion 201) from the rest of the structure.

Once the set is placed with the plies reinforcement, the draping of the intermediate portion 202 may be made.

This consists in the fresh draping of the entire inside 21 of the tooling 20 from upstream to downstream of the structure. Adhesive plies are attached to the areas where needed.

In the first alternative where the outer skin 2011 of the outer portion 201 is partial, the intermediate portion is also used as an outer skin in the downstream area of the structure. The number, orientation and disposition of the plies are left to the initiative of those skilled in the art.

In the second form where the outer skin 2011 extends to the downstream end of the outer portion 201, two cases maybe distinguished:
the draping of the intermediate skin stops at the downstream end of the core 2013,
the draping of the intermediate skin extends partially or entirely to the downstream end of the ferrule.

According to another form as shown in FIG. 10, the draping of the inner skin 2012 of the outer panel 201 may be made in a core 2013 spillover configuration 2013 in order to be used as a return reinforcement on the intermediate skin 202.

In addition, to remove an intermediate polymerizing cycle in the previous step 2, it is possible to arrange the intermediate tooling 20 with an elastomer-type counter-shape bladder 30 (shown in FIG. 10).

This bladder exerts pressure on the inner skin 2012 of the outer portion 201 at the same time as an outer vacuum bag presses down on the intermediate skin 202 during the common polymerizing phase.

Alternatively, the intermediate tooling 20 may reproduce directly the inner shapes of the outer skin 2011 if it does not undergo the intermediate polymerizing phase. Otherwise the outer shape of the intermediate tooling does not have any contact with the inner shape of the outer skin since it is already stiffened following its intermediate polymerizing step.

It should further be noted that intermediate tooling 20 may be a rigid structure over its entire length or be rigid only over a partial length and ending in length by the reinforced-silicone bladder or in association with a counter-plate positioned after the draping of the step 4 under the outer vacuum bag.

The fourth step consists in placing the inner portion 203 and the cores thereof (FIGS. 11 and 12).

The outer portion 201 being polymerized, a step of placing cores 2032 constituting the inner portion 203 of the cowl 2 is performed.

Advantageously the cores 2032 are prepared for be interfaced with the intermediate skin 202.

All cores are anchored on the structure and a phase of polymerizing this step may be made.

This polymerizing phase may be necessary if retouching and inner surfacing of the cores 2032 are required. Otherwise it is possible to proceed directly to the next step consisting in making the inner skin 2031 of the inner portion 203 (FIG. 11).

If it is not acoustic, the aerodynamic inner skin 2031 may be formed by fresh draping, if the laying support such as foam allows it.

In the case of an acoustic structure, it is necessary to make at least the acoustic skin by precooking to provide the desired quality of the aerodynamic line for an interface on a honeycomb and avoid prohibitive “telegraphing” for improved aerodynamic performances.

The skin may be perforated before gluing on the honeycomb.

Advantageously, a non-acoustic portion may be fresh-draped incorporating an upstream area covering of the acoustic skin as shown in the figure below. The fresh draping may go up to the most-upstream of the intermediate structure 202.

Once the inner portion assembled, we proceed to its polymerization.

The finished cowl 2 is shown in FIG. 13.

Although the present disclosure has been described with a particular exemplary form, it is evident that it is in no way limited and that it comprises all the technical equivalents of the means described as well as the combinations thereof if they fall within the scope of the present disclosure.

What is claimed is:

1. A method for manufacturing a part from composite material by a draping operation, said part having at least one convex inner surface, the method comprising:
disposing elements to make an outer portion of the part to be made on an inner surface of an outer manufacturing mold which defines at least in part lines of an outer surface of the part;
making the outer portion of the part by a plies laying method and at least partial polymerization of a resin;
installing an intermediate mold at a portion of an inner surface of the outer portion of the part, wherein an inner surface of the intermediate mold provides an interface with a remaining portion of the inner surface of the outer portion of the part, and defines at least in part, molding lines of an intermediate portion of the part to be made;
disposing elements to make the intermediate portion and making the intermediate portion by draping operation and at least partial polymerization of the resin; and
disposing on the intermediate portion, elements for a remaining inner portion to be made and making the remaining inner portion by draping operation and at least partial polymerization of the resin.

2. The method according to claim 1, further comprising an intermediate additional step of re-machining the made outer portion of the part.

3. The method according to claim 1, wherein steps of making the outer portion of the part and the intermediate portion are performed in one common step.

4. The method according to claim 1, wherein at least some of the elements of the inner portion are pre-polymerized prior to installation of remaining elements and a final polymerization.

5. A tooling for implementing a method for manufacturing a composite material part having at least one convex inner surface, the tooling comprising:
at least one outer manufacturing mold, an inner surface of which substantially defines outer lines of the composite material part to be made; and
at least one intermediate mold being disposed opposite to the inner surface of the at least one outer manufacturing mold, an inner surface of the at least one intermediate mold defining at least in part molding lines of an intermediate portion of the composite material part to be made.

6. The tooling according to claim 5, wherein the at least one intermediate mold is equipped with means for positioning relative to the at least one outer manufacturing mold.

7. The tooling according to claim 5, wherein the at least one intermediate mold is equipped with a counter-shape bladder oriented toward the inner surface of the at least one outer manufacturing mold and complementary to at least part of the molding surface of the outer manufacturing mold.

8. The tooling according to claim 5, wherein the at least one intermediate mold is equipped with at least one portion made of elastomer-type flexible material.

9. The tooling according to claim 8, wherein the at least one intermediate mold is equipped with at connecting angle irons.

10. The tooling according to claim 5, further comprising means for sealing between the at least one outer manufacturing mold and the at least one intermediate mold.

11. The tooling according claim 5, wherein the at least one outer manufacturing mold extends over at least 180° in circumference.
